(19) United States
(12) Patent Application Publication
(10) Pub. No.: US 2007/0002412 A1
(43) Pub. Date: Jan. 4, 2007

(54) Head-up display apparatus

(76) Inventor: Masami Aihara, Campbell, CA (US)

Correspondence Address: BRINKS HOFER GILSON & LIONE, P.O. BOX 10395, CHICAGO, IL, 60610, US

(21) Appl. No.: 11/173,546

(22) Filed: Jul. 1, 2005

(51) Int. Cl. G03H 1/00

(52) U.S. Cl. 359/13; 359/15

(57) ABSTRACT

A head-up display apparatus mainly includes a SH unit including switching hologram (SH) devices which constitute a combiner, a display device for supplying an image source to the SH unit, a light source controller for controlling the light source in the display device, a SH controller for controlling the SH devices, and a controller for controlling the entire apparatus including the light source controller and the SH controller.

### BACKGROUND OF THE INVENTION

1. Field of the Invention

The present invention relates to a head-up display apparatus, and more specifically to a head-up display apparatus for displaying a displayed image in the direction in which a viewer can easily see according to the position of the viewer.

2. Description of the Related Art

In recent years, a head-up display apparatus employing a holographic device as a display for motor vehicles is proposed. The head-up display apparatus enables a viewer to view information required for driving such as a speed and an environmental scene in an overlapped manner using holographic device.

In motor vehicles, since a mounting position of a head-up display apparatus with respect to a vehicle, a seat structure of the vehicle, and a physical constitution or a driving posture of a driver are different from each other, there is proposed a head-up display apparatus provided with a mechanism for enabling angular adjustment in the vertical direction so that a displayed image can be projected within a field of view of an arbitrary driver (Japanese Unexamined Patent Application Publication No. 10-278630).

However, the head-up display apparatus configured as described above has a problem such that the driver needs to change the orientation of the apparatus manually and the operation is complicated, although the angle adjusting mechanism is provided.

### SUMMARY OF THE INVENTION

In view of such circumstances, it is an object of the present invention to provide a head-up display apparatus which can direct a display within a field of view of an arbitrary driver with a very simple operation without changing the orientation of the apparatus.

The head-up display apparatus according to the invention includes a light source for emitting light, a switching hologram unit having at least two switching hologram devices each having different directions of diffraction with respect to the light from the light source, and a switching hologram control unit for applying a voltage to the switching hologram devices.

In this arrangement, by controlling application of the voltage to the switching hologram device, the state of diffraction of the switching hologram device can be controlled as desired to select the direction of diffraction. Therefore, the display can be directed within the field of view of the arbitrary driver with a very simple operation without changing the orientation of the apparatus.

According to the head-up display apparatus of the invention, the different directions of diffraction are preferably shifted in a vertical direction. In this configuration, for example, when used in the vehicle, even though the seat structure of the vehicle, the physical constitution or the driving posture of the driver are different, the respective driver can view the display in an easily viewable state.

According to the head-up display apparatus of the invention, the different directions of diffraction are preferably shifted in a horizontal direction. In this configuration, for example, when used in the vehicle, the display can be viewed from a driver's seat and from a passenger's seat respectively in the easily viewable state.

The head-up display apparatus of the invention includes light sources for emitting lights of different colors respectively, a switching hologram unit having at least two switching hologram devices indicating the state of diffraction according to the lights of the respective colors, a switching hologram control unit for applying a voltage to the switching hologram devices, a light source control unit for switching light emitted from the light source, and a timing control unit for controlling a timing of switching the light source controller and a timing of applying the voltage to the switching hologram devices.

In this arrangement, color display on the head-up display apparatus employing the holographic devices by the control of voltage application to the switching hologram devices and the control of switching of the light sources can be realized.

According to the head-up display apparatus of the invention, the switching hologram device preferably includes a pair of supporting substrates having an electrode on one of main surfaces and being disposed so that the respective electrodes oppose each other, and a switching hologram layer configured in such a manner that liquid crystal layers and polymer layers are disposed alternately so as to extend between the electrodes.

Since the head-up display of the invention includes the light source for emitting light, the switching hologram unit having at least two switching hologram devices having different directions of diffraction respectively with respect to the light from the light sources, and switching hologram control unit for applying the voltage to the switching hologram device or devices which correspond(s) to the direction of diffraction not used, the display can be directed within the field of view of the arbitrary driver in a very simple operation without changing the orientation of the apparatus.

### BRIEF DESCRIPTION OF THE DRAWINGS

FIG. 1 is a drawing showing a schematic structure of a head-up display apparatus according to a first embodiment of the present invention;

FIG. 2 is a drawing showing a structure of a switching hologram device used in the head-up display apparatus according to the embodiment of the invention;

FIGS. 3A and 3B are explanatory drawings showing an operation of the switching hologram device shown in FIG. 2;

FIGS. 4A to 4C are explanatory drawings showing a process in which a high polymer layer of the switching hologram device is formed;

FIG. 5 is an explanatory drawing showing an interference exposure of the switching hologram device;

FIG. 6 is a drawing showing a schematic structure of the head-up display apparatus according to a second embodiment of the invention; and

FIG. 7 is a drawing showing a schematic structure of the head-up display apparatus according to a third embodiment of the invention.

### DESCRIPTION OF THE PREFERRED EMBODIMENTS

Referring now to the attached drawings, embodiments of the invention will be described in detail.

### First Embodiment

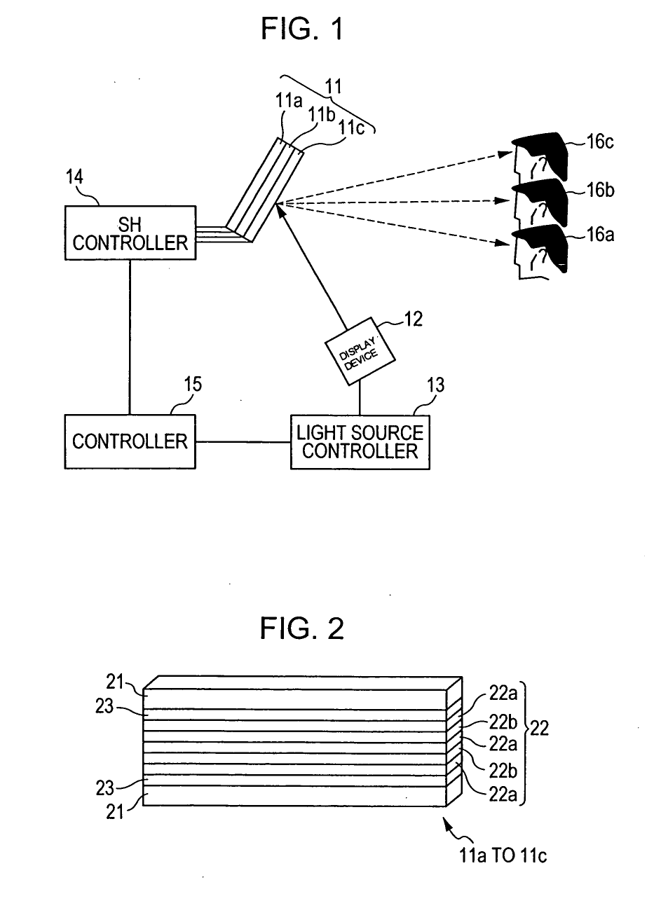

In this embodiment, a head-up display apparatus which is used in the motor vehicle, and is capable of shifting the direction of diffraction in the vertical direction will be described. FIG. 1 is a drawing showing a general structure of a head-up display apparatus according to a first embodiment of the invention.

The head-up display apparatus shown in FIG. 1 mainly includes a switching hologram (hereinafter, abbreviated as SH) unit 11 having SH devices 11a to 11c which constitute a combiner, a display device 12 for supplying an image source to the SH unit 11, a light source controller 13 for controlling the light source of the display device 12, a SH controller 14 for controlling the SH devices 11a to 11c, and a controller 15 for controlling the entire apparatus including the light source controller 13 and the SH controller 14.

The SH unit 11 includes a plurality of SH devices, in this case, three SH devices 11a-11c. The SH devices 11a to 11c are optical devices which diffract light from the light source in the directions different in the vertical directions respectively, and transmit light from the light source by applying a voltage. The SH devices 11a to 11c of the SH unit 11 correspond positions 16a to 16c of a head (eye) of the viewer, respectively. In other words, the SH device 11a is set to a state of diffraction in which the direction of diffraction (direction of light after diffraction) is directed toward the viewer's head position 16a, the SH device 11b is set to a state of diffraction in which the direction of diffraction is directed toward the viewer's head position 16b, and the SH device 11c is set to a state of diffraction in which the direction of diffraction is directed toward the viewer's head position 16c.

The state of diffraction of each of the SH device 11a to 11c changes with the magnitude of voltage, and has a structure as shown in FIG. 2. FIG. 2 is a drawing showing a structure of the SH device used in the head-up display apparatus according to the embodiment of the invention. The SH devices 11a to 11c each includes a pair of supporting substrates 21 and a polymer-liquid crystal layer (SH layer) 22 interposed between the supporting substrates 21. Provided on the inner side of each supporting substrates 21, that is, on a side of the polymer-liquid crystal layer 22, is an electrode 23 for applying a voltage. The supporting substrates 21 and the electrodes 23 are preferably transparent. Therefore, as the supporting substrates 21, transparent substrates such as glass substrates or transparent resin substrates are preferably used, while as the electrodes 23, transparent electrodes such as ITO electrodes are preferably used. The polymer-liquid crystal layer 22 is a holographic-polymer distributed liquid crystal layer, and includes polymer layers 22a and liquid crystal layers 22b. The respective polymer layers 22a and liquid crystal layers 22b extend between the opposed electrodes 23. Therefore, the polymer-liquid crystal layer 22 has a stripe structure in which the polymer layers 22a and the liquid crystal layers 22b are disposed alternately.

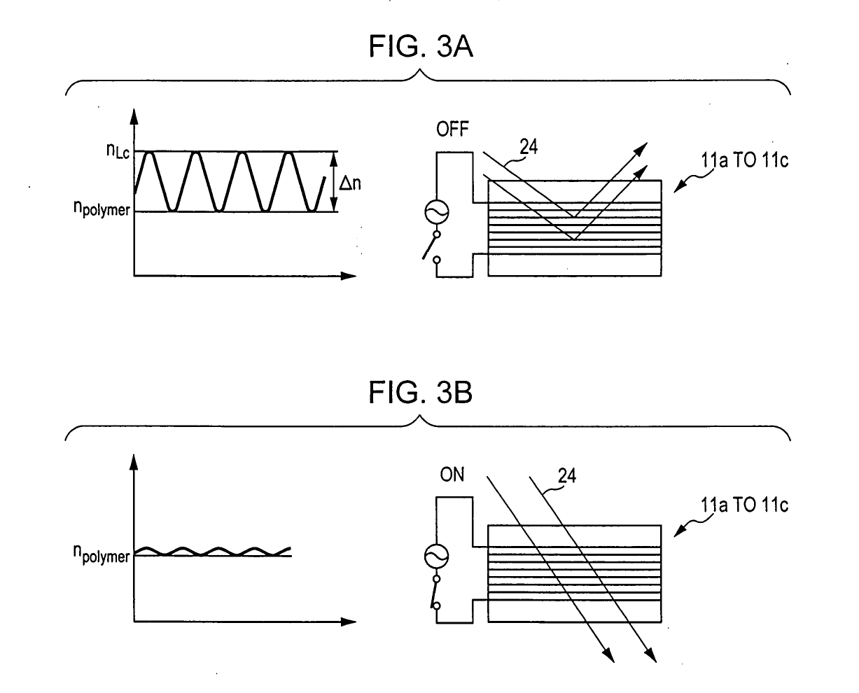

Since the SH devices 11a-11c each includes the polymer layers 22a and the liquid crystal layers 22b, which are different in refractive index as described above, disposed alternately, difference in refractive index appears periodically in the SH device. Therefore, in a state in which the voltage is not applied (OFF), as shown in FIG. 3A, a difference Δn between a refractive index of the polymer layer 22a and a refractive index of the liquid crystal layer 22b exists. Therefore, when a light 24 passes through the SH devices 11a to 11c in the OFF state, the Bragg diffraction occurs, and the optical path is changed. On the other hand, in a state in which a voltage is applied (ON), as shown in FIG. 3B, since the difference Δn between the refractive index of the polymer layer 22a and the refractive index of the liquid crystal layer 22b disappears, when the light 24 passes through the SH devices 11a to 11c in the ON state, it proceeds as is.

In the SH devices 11a-11c, the orientation of the liquid crystal molecules contained in the liquid crystal layers 22b changes in response to the electric field. Since the liquid crystal molecules have anisotropy of refractive index, the difference Δn between the refractive index of the polymer layer 22a and the refractive index of the liquid crystal layer 22b changes by application of electric field. Using this change, polarization and separation of light may be achieved. Since the thickness of the polymer layer 22a or the liquid crystal layer 22b of the SH device corresponds to the intervals of the Bragg lattice, the diffraction angle can be changed by changing the thickness of the polymer layer 22a or the liquid crystal layer 22b. Therefore, by changing the thickness, the SH device which corresponds to the viewer's head positions 16a to 16c can be manufactured. In other words, by changing the distance or inclination of the interference fringe by changing conditions of laser exposure, described later, the SH device corresponding to the viewer's head positions 16a to 16c can be obtained.

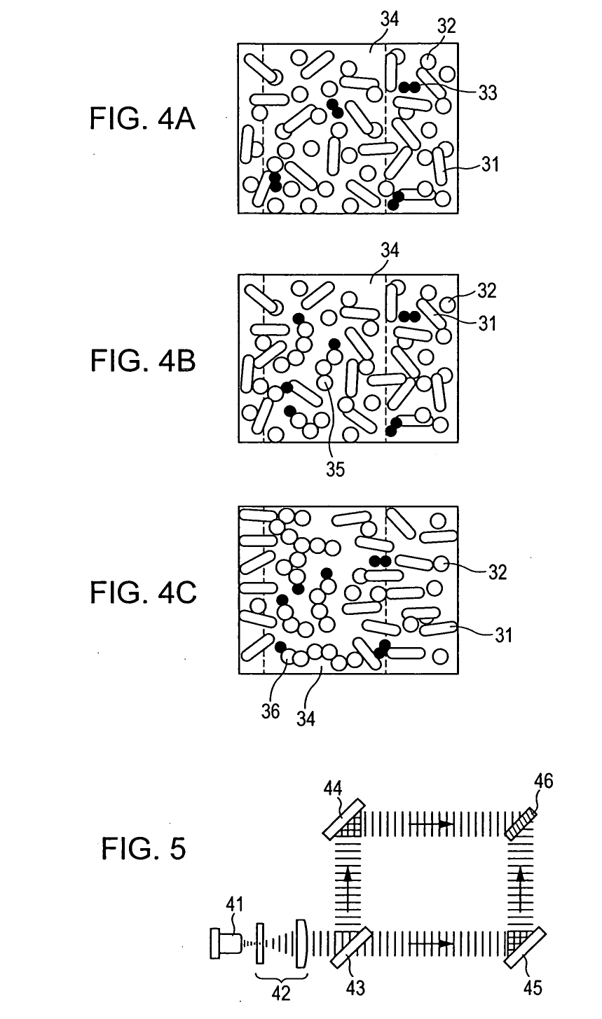

The SH devices 11a to 11c are manufactured via a process shown in FIG. 4. In other words, as shown in FIG. 4A, a layer of mixture of liquid crystal molecules 31, monomers 32, illumination starting agents 33 are exposed by a laser. At this time, polymerization starts in a bright portion 34 of the interference fringe generated by laser exposure. Then, as shown in FIG. 4B, when the monomers 32 are subjected to polymerization and become prepolymer molecules 35, the liquid crystal molecules 31 are rejected. Subsequently, as shown in FIG. 4C, polymerization is proceeded to generate polymer molecules 36, whereby the polymer layer (bright portion of the interference fringe) and the liquid crystal layer (dark portion of the interference fringe) are formed.

The laser exposure can be performed by an apparatus as shown in FIG. 5. In other words, light emitted from a laser 41 is expanded in beam diameter by a beam expander 42, and then is split into two coherent beams by a beam splitter 43, which are then redirected respectively to different optical paths by mirrors 44, 45, and are irradiated on a substrate 46 having a layer mixed with liquid crystal molecules 31, the monomers 32, the illumination starting agents 33. Accordingly, interference exposure is performed on the substrate 46, where the interference fringe is formed via the process described above.

The SH unit 11 is obtained by bonding the SH devices 11a to 11c manufactured in the manner described above. When bonding the SH devices 11a to 11c, adhesive agent which matches the refractive index of the supporting substrates 21 to be bonded is used. Although a case in which the SH devices shown in FIG. 2 are manufactured and these two SH devices are bonded is described here, a configuration in which three SH layers are interposed between the pair of supporting substrates like supporting substrate/electrode/SH layer/electrode/insulating plate/electrode/SH layer/electrode/insulating plate/electrode/SH layer/electrode/supporting substrate may also be applicable.

Display device 12 includes at least a light source such as a cold-cathode tube or LED, and a display unit such as a liquid crystal display unit. The display unit is adapted to be supplied with an image data to be displayed by the combiner. Therefore, in the display device 12, the image data is supplied to the display unit, and is display-controlled in the display unit, whereby predetermined display is resulted. The display is projected by the light source, and is sent to the SH unit 11 which constitutes the combiner as an image source.

The light source controller 13 controls the light source of the display device 12 based on an instruction from the controller 15. For example, it controls switching of the light source between ON and OFF. Also, it is also possible to send a control signal to the SH controller 14 when the light source controller 13 controls the light source, for example turns ON, to control the SH unit 11 in association with the ON control of the light source.

The SH controller 14 controls voltage application of the SH unit 11 to the SH devices 11a to 11c. More specifically, it applies a voltage to the SH devices 11a to 11c which correspond to the directions of diffraction not used. In other words, the voltage is applied to the SH devices 11b, 11c, but not to the SH device 11a when setting of the direction of diffraction at the viewer's head position 16a is desired, the voltage is applied to the SH devices 11a, 11c, but not to the SH device 11b when setting of the direction of diffraction at the viewer's head position 16b is desired, and the voltage is applied to the SH devices 11a, 11b, but not to the SH device 11c when setting of the direction of diffraction at the viewer's head position 16c is desired.

Subsequently, the operation of the head-up display apparatus according to this embodiment will be described. Firstly, a case in which the display is directed to the viewer's head position 16a will be described. When a switch of the combiner is turned on, the controller 15 outputs a control signal which indicates that the switch is turned on to the light source controller 13. The light source controller 13 controls to turn the light source of the display device 12 and the display unit ON according to the control signal. An image data is sent to the display unit, which is display-controlled in the display unit. The display on the display unit is sent to the SH unit 11 which constitutes the combiner. The instruction to direct the display to the viewer's head position 16a is sent to the SH controller 14 from the controller 15. The SH controller 14 controls voltage application to the SH devices 11a to 11c according to the control signal corresponding to the instruction. In other words, the voltage is not applied to the SH device 11a (OFF), and the voltage is applied to the SH devices 11b, 11c (ON). Since the voltage is not applied to the SH device 11a in the SH unit 11 in this state of diffraction, light is diffracted in the SH device 11a as shown in FIG. 3A. Since the SH device 11a is manufactured so that the direction of diffraction is directed to the viewer's head position 16a in advance, the display from the display device 12 is sent toward the viewer's head position 16a. On the other hand, in the SH devices 11b, 11c, light is transmitted by voltage application as shown in FIG. 3B. Therefore, the light diffracted in the SH device 11a is not affected. Consequently, the viewer at the head position 16a can view the display in the easily viewable state.

Subsequently, a case of switching the display to the viewer's head position 16b will be described. In this case, the instruction to switch the display to the viewer's head position 16b is sent to the SH controller 14 from the controller 15. The SH controller 14 controls voltage application to the SH devices 11a to 11c according to the control signal corresponding to the instruction. In other words, the voltage is not applied to the SH device 11b (OFF) and the voltage is applied to the SH devices 11a, 11c (ON). Since the voltage is not applied to the SH device 11b in the SH unit 11 in this state of diffraction, light is diffracted in the SH device 11b as shown in FIG. 3A. Since the SH device 11b is manufactured so that the direction of diffraction is directed to the viewer's head position 16b in advance, the display from the display device 12 is sent toward the viewer's head position 16b. On the other hand, in the SH devices 11a, 11c, light is transmitted by voltage application as shown in FIG. 3B. Therefore, light diffracted in the SH device 11b is not affected. Consequently, the viewer at the head position 16b can view the display in the easily viewable state. A case of switching the display to the viewer's head position 16c is the same as the case described above.

In this manner, since the head-up display apparatus according to this embodiment can control the state of diffraction of the desired SH device to select the direction of diffraction by controlling voltage application to the SH devices 11a to 11c, the display can be directed within the field of view of the arbitrary driver with a very simple operation without changing the orientation of the apparatus. In particular, in this embodiment, even though the structure of the seat in the vehicle or the physical constitution or the driving posture of the driver is different, the respective driver can view the display in the easily viewable state.

### Second Embodiment

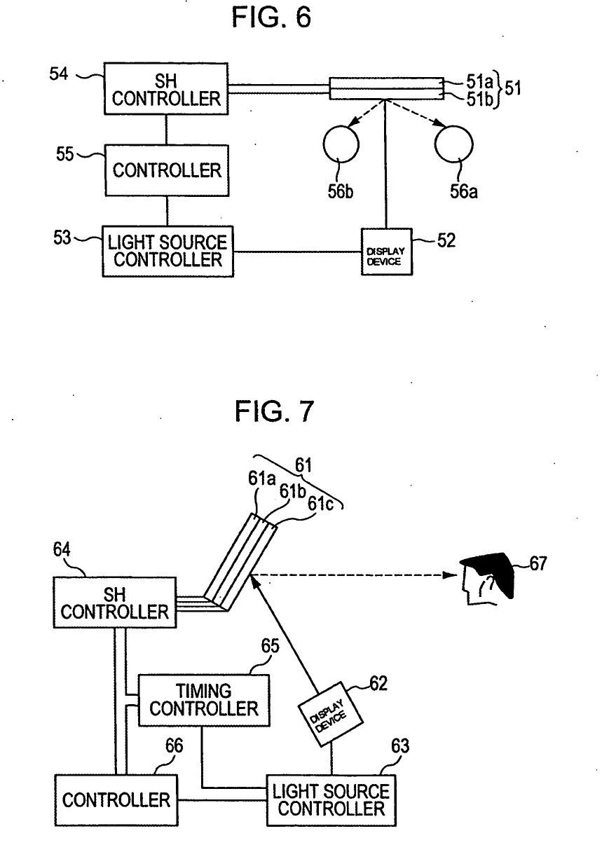

In this embodiment, a head-up display apparatus which is used in the motor vehicle and can shift the direction of diffraction in the horizontal direction will be described. FIG. 6 is a drawing showing a general structure of a head-up display apparatus according to a second embodiment of the invention. FIG. 6 shows a layout in the vehicle when an interior of the vehicle is viewed from above.

The head-up display apparatus shown in FIG. 6 includes a SH unit 51 having SH devices 51a, 51b which constitute a combiner, a display device 52 for supplying an image source to the SH unit 51, a light source controller 53 for controlling a light source in the display device 52, a SH controller 54 for controlling the SH devices 51a, 51b, and a controller 55 for controlling the entire apparatus including the light source controller 53 and the SH controller 54.

The SH unit 51 includes a plurality of SH devices, two in this embodiment, SH devices 51a, 51b. The SH devices 51a, 51b are optical devices which diffract light from the light source in the directions of diffraction different in the horizontal direction, and transmit the light from the light source by voltage application. The SH devices 51a, 51b in the SH unit 51 corresponds to viewer's head positions 56a, 56b. In other words, the state of diffraction of the SH device 51a is set so that the direction of diffraction (direction of light after diffraction) is directed toward the viewer's head position 56a, and the state of diffraction of the SH device 51b is set so that the direction of diffraction is directed toward the viewer's head position 56b.

The display device 52 and the light source controller 53 are the same as the display device 12 and the light source controller 13 in the head-up display apparatus in the first embodiment. The SH controller 54 controls voltage application to the SH devices 51a, 51b of the SH unit 51. More specifically, the voltage is applied to one of the SH devices 51a, 51b which corresponds to the direction of diffraction not used. In other words, when setting of the direction of diffraction at the viewer's head position 56a is desired, the voltage is applied to the SH device 51b, and not to the SH device 51a, and when setting of the direction of diffraction at the viewer's head position 56b is desired, the voltage is applied to the SH device 51a, and not to the SH device 51b.

Subsequently, the operation of the head-up display apparatus according to this embodiment will be described. Firstly, a case in which the display is directed to the viewer's head position 56a will be described. When a switch of the combiner is turned ON, the controller 55 outputs a control signal which indicates that the switch is turned on to the light source controller 53. The light source controller 53 controls to turn the light source of the display device 52 and the display unit ON according to the control signal. An image data is sent to the display unit, which is display-controlled in the display unit. The display on the display unit is sent to the SH unit 51 which constitutes the combiner by the light source. The instruction to direct the display to the viewer's head position 56a is sent to the SH controller 54 from the controller 55. The SH controller 54 controls voltage application to the SH devices 51a, 51b according to the control signal corresponding to the instruction. In other words, the voltage is not applied to the SH device 51a (OFF) and the voltage is applied to the SH device 51b (ON). In the SH unit 51 in this state of diffraction, since the voltage is not applied to the SH device 51a, light is diffracted in the SH device 51a as shown in FIG. 3A. Since the SH device 51a is manufactured so that the direction of diffraction is directed to the viewer's head position 56a in advance, the display from the display device 52 is sent toward the viewer's head position 56a. On the other hand, in the SH device 51b, the light is transmitted by voltage application as shown in FIG. 3B. Therefore, the light diffracted in the SH device 51a is not affected. Consequently, the viewer at the head position 56a can view the display in the easily viewable state.

Subsequently, a case of switching the display to the viewer's head position 56b will be described. In this case, the instruction to switch the display to the viewer's head position 56b is sent to the SH controller 54 from the controller 55. The SH controller 54 controls voltage application to the SH devices 51a, 51b according to the control signal corresponding to the instruction. In other words, the voltage is not applied to the SH device 51b (OFF) and the voltage is applied to the SH device 51a (ON). Since the voltage is not applied to the SH device 51b in the SH unit 51 in this state of diffraction, light is diffracted in the SH device 51b as shown in FIG. 3A. Since the SH device 51b is manufactured so that the direction of diffraction is directed to the viewer's head position 56b in advance, the display from the display device 52 is sent toward the viewer's head position 56b. On the other hand, in the SH device 51a, light is transmitted by voltage application as shown in FIG. 3B. Therefore, light diffracted in the SH device 51b is not affected. Consequently, the viewer at the head position 56b can view the display in the easily viewable state.

In this manner, since the head-up display apparatus according to this embodiment can control the state of diffraction of the desired SH device to select the direction of diffraction by controlling voltage application to the SH devices 11a to 11c, the display can be directed within the field of view of the arbitrary driver with a very simple operation without changing the orientation of the apparatus. In particular, in this embodiment, the display can be viewed from the driver's seat and the passenger's seat in the easily viewable state. Also, in this embodiment, it may also be configured in such a manner that the voltage application to the SH unit 51 is automatically controlled by the controller 55 when the display to be directed toward the passenger's seat is sent to the display device 52. For example, the voltage application to the SH unit 51 may be controlled in such a manner that the display is basically sent only to the passenger's seat when an image to be displayed by the combiner is a TV video.

### Third Embodiment

In this embodiment, a head-up display apparatus which is used in the motor vehicle, and is capable of color display will be described. FIG. 7 is a drawing showing a schematic structure of the head-up display apparatus according to a third embodiment of the invention.

The head-up display apparatus shown in FIG. 7 mainly includes a SH unit 61 having SH devices 61a to 61c which constitute a combiner, a display device 62 for supplying an image source to the SH unit 61, a light source controller 63 for controlling the light source of the display device 62, a SH controller 64 for controlling the SH devices 61a to 61c, a timing controller 65 for controlling the timing of controlling the light source in the light source controller 63 and of controlling the SH devices in the SH controller 64, and a controller 66 for controlling the entire apparatus including the light source controller 63, the SH controller 64, and the timing controller 65.

The SH unit 61 includes a plurality of SH devices, three in this embodiment, SH devices 61a to 61c. The SH devices 61a to 61c are optical devices which correspond respectively to the light sources of different colors of red, green, and blue, diffract lights of the respective colors, and transmit the light by voltage application. In this embodiment, the SH device 61a in the SH unit 61 corresponds to the light source which emits red light, the SH device 61b corresponds to the light source which emits green light, and the SH device 61c corresponds to the light source which emits blue light. In other words, the SH device 61a is manufactured to have a state of diffraction which diffracts red light, the SH device 61b is manufactured to have a state of diffraction which diffracts green light, and the SH device 61c is manufactured to have a state of diffraction which diffracts blue light. In this case, by changing the intervals or inclination of the interference fringe by changing conditions of the laser exposure, the SH devices which correspond to red light, green light, and blue light are obtained. The directions of diffraction of these SH devices 61a to 61c are set to substantially the same direction.

The display device 62 at least includes a light source such as a cold-cathode tube or LED, and a display unit such as a liquid crystal display unit. The display unit is adapted to be supplied with an image data to be displayed by the combiner. Therefore, in the display device 62, the image data is supplied to the display unit, and is display-controlled in the display unit, whereby predetermined display is resulted. The display is projected by the light source, and is sent to the SH unit 61 which constitutes the combiner as an image source. In this embodiment, a plurality of (three in this case) the light sources are prepared, and the display is projected on the SH unit 61 by the respective light sources. A plurality of light sources may be prepared, or a single light source which can emit lights in a plurality of different colors may be prepared since what is required is to emit lights in a plurality of different colors.

The light source controller 63 controls the light source of the display device 62 according to the timing controlled by the timing controller 65, which will be described later. In other words, the light source which emits red light, the light source which emits green light, and the light source which emits blue light are switched, so that the color displayed on the SH unit 61 is controlled. The light source controller 63 controls the light source of the display device 62 based on the instruction from the controller 66. For example, it controls switching of the light source between ON and OFF. It is also possible to adapt in such a manner that a control signal is sent to the SH controller 64 when the light source controller 63 controls the light source, for example, turns ON, and controls the SH unit in association with turning ON control of the light source.

The SH controller 14 controls voltage application to the SH devices 61a to 61c of the SH unit 61 according to the timing controlled by the timing controller 65, which will be described later. More specifically, the voltage application to the SH devices 61a to 61c is controlled for each color emitted from the light source. In other words, the voltage is applied to the SH devices 61b, 61c but not to the SH device 61a when red light is emitted, the voltage is applied to the SH devices 61a to 61c but not to the SH device 61b when green light is emitted, and the voltage is applied to the SH devices 61a, 61b, but not to the SH device 61c when blue light is emitted.

The timing controller 65 controls the timing of switching the light source by the light source controller 63 and the timing of voltage application to the SH device of the SH controller 64. In other words, it controls to synchronize the timing of switching the light source by the light source controller 63 and the timing of voltage application to the SH device of the SH controller 64. Therefore, the SH device 61a which corresponds to red light is turned OFF, and other SH devices 61b, 61c are turned ON by the SH controller 64 when emitting red light under the control of the light source controller 63, the SH device 61b corresponding to green light is turned OFF and other SH devices 61a to 61c are turned ON when emitting green light under the control of the light source controller 63, and the SH device 61c corresponding to blue light is turned OFF and other SH devices 61a, 61b are turned ON under the control of the SH controller 64 when emitting blue light under the control of the light source controller 63. The timing of switching the light source and the timing of voltage application may be a timing employed in driving a display of a field sequential system, for example. Accordingly, the viewer can view the display on the combiner as a color display. By such a control of the timing controller 65, the color display of the head-up display apparatus is achieved.

Subsequently, the operation of the head-up display according to this embodiment will be described. First, a case in which the display on the combiner is effected by the use of red light will be described. When the switch of the combiner is turned on, the controller 66 outputs a control signal which indicates that the switch is turned on to the light source controller 63. The light source controller 63 controls to turn the light source of the display device 62 and the display unit ON according to the control signal. An image data is sent to the display unit, which is display-controlled in the display unit. During red display period, the display on the display unit is sent to the SH unit 61 which constitutes the combiner by the red light source. The instruction to use the SH device 61a which corresponds to the red light source is sent from the controller 66 to the timing controller 65. The timing controller 65 controls voltage application to the SH devices 61a to 61c according to the control signal corresponding to the instruction. In other words, the voltage is not applied to the SH device 61a (OFF) and the voltage is applied to the SH devices 61b, 61c (ON). The control period (field period) is performed, for example, for about ⅓ frame in the field sequential system. In the SH unit 61 in such a state of diffraction, since the voltage is not applied to the SH device 61a, the red light is diffracted in the SH device 61a as shown in FIG. 3A. This diffracted light is viewed by a viewer 67. On the other hand, in the SH devices 61b, 61c, light is transmitted by voltage application as shown in FIG. 3B. Therefore, the light diffracted in the SH device 61a is not affected. Consequently, the viewer 67 views the red light.

Subsequently, during the green display period, the display on the display unit is sent to the SH unit 61 which constitutes the combiner by the green light source. The instruction to use the SH device 61b corresponding to the green light source is sent to the timing controller 65 from the controller 66. The timing controller 65 controls the voltage application to the SH devices 61a to 61c according to the control signal corresponding to the instruction. In other words, the voltage is not applied to the SH device 61b (OFF), and the voltage is applied to the SH devices 61a to 61c (ON). This control period (field period) is about ⅓ frame (the frame repeating frequency is about 180 Hz), for example, in the field sequential system. In the SH unit 61 in such a state of diffraction, since the voltage is not applied to the SH device 61b, the red light is diffracted in the SH device 61b as shown in FIG. 3A. The diffracted light is viewed by the viewer 67. On the other hand, in the SH devices 61a to 61c, light is transmitted by voltage application as shown in FIG. 3B. Therefore, the light diffracted in the SH device 61b is not affected. Consequently, the viewer 67 views the green display. In addition, during blue display period, the voltage is not applied to the SH device 61c (OFF) and the voltage is applied to the SH devices 61a, 61b (ON), and the display on the display unit is sent to the SH unit 61 which constitutes the combiner by the blue light source in the same manner as described above.

When the respective display periods are on the order of ⅓ frame (the frame repetition frequency is about 180 Hz), since the viewer 67 cannot view the display periods of the respective colors separately, he/she views the display generally as the color display. In this manner, the head-up display apparatus according to this embodiment can achieve the color display with the head-up display apparatus employing the holographic devices by the control of voltage application to the SH devices 61a to 61c, and the control of switching of the light source.

In this embodiment, the case in which the color display is achieved by switching the three colors of red, green, and blue one by one has been described. However, in the present invention, a full color display can also be realized by controlling the timing of switching the light source in these three colors and the timing of voltage application to the SH devices to display in a plurality of colors in one display period.

According to the head-up display apparatus in the first to third embodiments, when it is not used as the head-up display, the combiner can be substantially transparentized by applying the voltage to all the SH devices. Accordingly, the field of view is prevented from being intercepted when the head-up display apparatus is not used.

The invention is not limited to the first to third embodiments, and may be implemented by modifying in various manners. In the first to third embodiments, a case in which two or three SH devices are employed is described. However, four or more SH devices may also be employed in the invention. In the first to third embodiments, a case in which the head-up display apparatus of the invention is installed in the vehicle is described. However, the invention is not limited thereto, and may be applied to applications in which the display is to be directed in the arbitrary plurality of directions. Other modifications may also be made without departing the scope of the invention.

What is claimed is:

1. A head-up display apparatus comprising:
a light source for emitting light;
a switching hologram unit having at least two switching hologram devices each having different directions of diffraction with respect to the light from the light source; and
a switching hologram control unit for applying a voltage to the switching hologram devices.

2. The head-up display apparatus according to claim 1, wherein the different directions of diffraction are shifted in a vertical direction.

3. The head-up display apparatus according to claim 1, wherein the different directions of diffraction are shifted in a horizontal direction.

4. A head-up display apparatus comprising:
light sources for emitting lights of different colors respectively;
a switching hologram unit having at least two switching hologram devices indicating the state of diffraction according to the lights of the respective colors;
a switching hologram control unit for applying a voltage to the switching hologram devices;
a light source control unit for switching light emitted from the light source; and
a timing control unit for controlling a timing of switching the light source control unit and a timing of applying the voltage to the switching hologram devices.

5. The head-up display apparatus according to claim 1 to claim 4, wherein the switching hologram device preferably comprises a pair of supporting substrates having an electrode on one of main surfaces and being disposed so that the respective electrodes oppose each other, and a switching hologram layer configured in such a manner that liquid crystal layers and polymer layers are disposed alternately so as to extend between the electrodes.

6. The head-up display apparatus according to claim 2, wherein the switching hologram device preferably comprises a pair of supporting substrates having an electrode on one of main surfaces and being disposed so that the respective electrodes oppose each other, and a switching hologram layer configured in such a manner that liquid crystal layers and polymer layers are disposed alternately so as to extend between the electrodes.

7. The head-up display apparatus according to claim 3, wherein the switching hologram device preferably comprises a pair of supporting substrates having an electrode on one of main surfaces and being disposed so that the respective electrodes oppose each other, and a switching hologram layer configured in such a manner that liquid crystal layers and polymer layers are disposed alternately so as to extend between the electrodes.

8. The head-up display apparatus according to claim 4, wherein the switching hologram device preferably comprises a pair of supporting substrates having an electrode on one of main surfaces and being disposed so that the respective electrodes oppose each other, and a switching hologram layer configured in such a manner that liquid crystal layers and polymer layers are disposed alternately so as to extend between the electrodes.
